(19) United States
(12) Patent Application Publication
(10) Pub. No.: US 2013/0292893 A1
(43) Pub. Date: Nov. 7, 2013

(54) JIG FOR FIXING CYLINDER BLOCK

(71) Applicant: Masato Yoshida, Nissin-shi (JP)

(72) Inventor: Masato Yoshida, Nissin-shi (JP)

(73) Assignee: TOYOTA JIDOSHA KABUSHIKI KAISHA, Toyota-shi (JP)

(21) Appl. No.: 13/988,623

(22) PCT Filed: Nov. 22, 2010
(86) PCT No.: PCT/JP2010/070789

§ 371 Date: Jul. 23, 2013

(51) Int. Cl. B23Q 3/06

(52) U.S. Cl. CPC B23Q 3/069
USPC 269/134

(57) ABSTRACT

The present invention addresses the issue of providing a jig for fixing a cylinder block, said jig being capable of stably fixing a cylinder block and contributing to a reduction of the size of the whole equipment including a processing tool. A jig for fixing a cylinder block of the present invention is used for the purpose of fixing a cylinder block, and is provided with a table having the cylinder block placed thereon such that the crank cases of the cylinder block are positioned on the lower side, and a clamping device, which can project upward from the upper surface of the table, and which clamps a journal wall that separates the crank cases of the cylinder block from each other.

This is a 371 national phase application of PCT/JP2010/070789 filed 22 Nov. 2010, the contents of which are incorporated herein by reference.

### FIELD OF THE INVENTION

The present invention relates to a jig for fixing a cylinder block.

### BACKGROUND OF THE INVENTION

The cylinder block is fixed by a fixing device such as a jig while the cylinder block is processed, e.g., cut, drilled and the like.

In the conventional technique, the cylinder block is clamped externally and fixed. However, such fixing device may be large size, and the fixing device may contact the processing tool, and therefore there needs an improvement.

For instance, JP 2001-113433 A discloses a clamping device including a rod inserted into a bore of the cylinder block and a clamping arm for pressing the inside of the bore, provided at the end of the rod. In the clamping device, the rod and the clamping arm are inserted from lower opening of the cylinder block and the clamping arm is pressed to a projection formed in the inside of the bore, thereby fixing the cylinder block.

In JP 2001-113433 A, the rod needs the length to reach the bore that is located at the upper portion of the cylinder block from the lower end. Thus, the length of the rod is long, so that the rigidity of the rod may be low and the rod may be weakened against the bending moment acted on the clamping arm. As the result, the clamping device may fail to clamp firmly.

Moreover, the fixing direction of the clamping arm is limited to the formed direction of the projection of the bore, and thus it is difficult to maintain the sufficient clamping force against the external force in the direction perpendicular to that fixing direction.

### CITATION LIST

### Patent Literature

PTL 1: JP 2001-113433 A

### SUMMARY OF INVENTION

### Technical Problem

The objective of the present invention is to provide a jig for fixing a cylinder block being enabled to fix the cylinder block firmly and to downsize whole equipment including a processing tool.

### TECHNICAL SOLUTIONS

The first aspect of the present invention is a jig for fixing a cylinder block including: a table on which the cylinder block is mounted such that crank cases of the cylinder block are located downside; and a clamping device capable of projecting upward from the top of the table, clamping a journal wall disposed between the adjacent crank cases. The clamping device includes two clamping arms, and each of the clamping arms is inserted into each of the crank cases adjacent to each other, whereby the clamping arms clamp the journal wall disposed between those crank cases.

Preferably, the clamping device pulls in the cylinder block downward to press the cylinder block toward the table in the state that the clamping device clamps the journal wall of the cylinder block.

Advantageously, the clamping device clamps a part of the journal wall, the part is located at the side of bearing portion for a crank shaft.

### ADVANTAGEOUS EFFECTS OF INVENTION

According to the present invention, it is enabled to fix the cylinder block firmly and to downsize whole equipment including a processing tool.

### BRIEF DESCRIPTION OF DRAWINGS

FIG. 1 is a section view of a cylinder block.

FIG. 2 depicts a jig for fixing the cylinder block.

FIG. 3 illustrates an action of a clamping device.

FIG. 4 illustrates a clamping action in which the clamping device clamps the cylinder block.

FIG. 5 shows a clamping position of the clamping device.

### DETAILED DESCRIPTION

Referring to drawings, a jig 1 is described below. The jig 1 is used for fixing a cylinder block 2 to be processed with fixed by the jig.

For convenience of explanation, the vertical direction and the lateral direction of the drawings are defined as those of the jig 1 and the cylinder block 2.

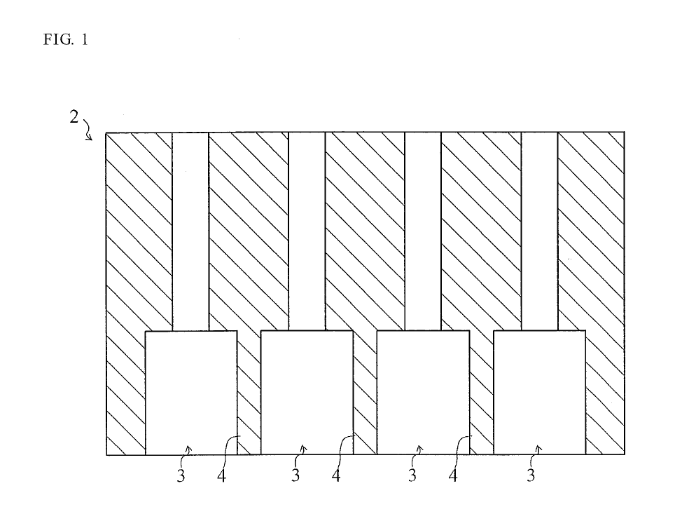

As depicted in FIG. 1, the cylinder block 2 has crank cases 3 for housing a crank shaft and journal walls 4 including bearing portions for the crank shaft, each of which is disposed between the adjacent crank cases 3. The cylinder block 2 has four cylinders arranged in the lateral direction.

The journal wall 4 is located at the lower end of the cylinder block 2, opposite side of the cylinder head, and includes a bearing portion 5 formed in semicircle. The journal wall 4 composes a part of the inside wall of the crank case 3, and supports the crank shaft at the bearing portion 5.

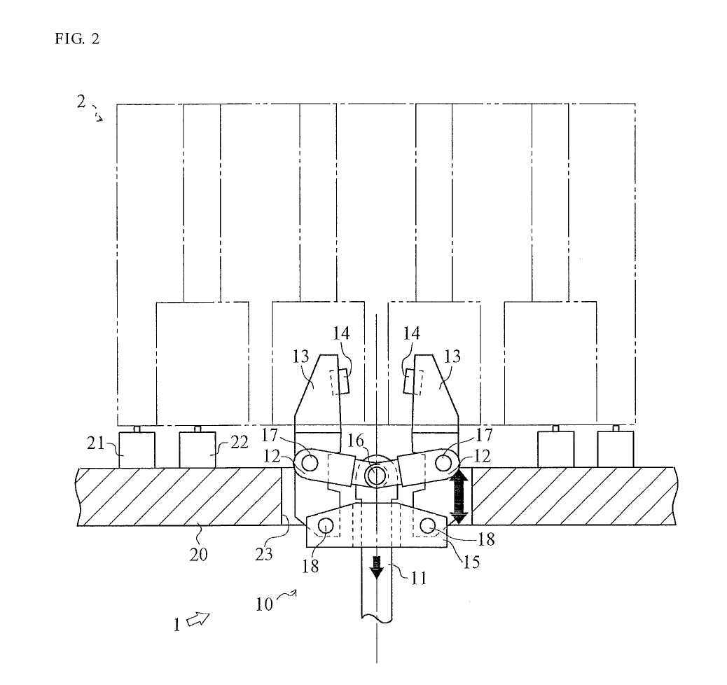

As depicted in FIG. 2, the jig 1 includes a clamping device 10 and a table 20. The clamping device 10 clamps the journal wall 4 of the cylinder block 2 from the lower side. The table 20 is provided with multiple positioning seats 21 and multiple positioning pins 22, both of which are located according to the shape and size of the cylinder block 2. These positioning seats and pins are used for positioning of the cylinder block 2, and the cylinder block is mounted on the table. The table 20 is formed with a hole 23, through which the clamping device 10 moves in the vertical direction, and from which the clamping device is projected upward from the top of the table 20.

When the jig 1 is used for fixing the cylinder block 2, the cylinder block 2 is mounted on the table 20 such that the crank cases 3 and the journal walls 4 are located downside. The clamping device 10 clamps the journal walls 4 of the cylinder block 2 from the bottom side, thereby fixing the cylinder block.

As shown in FIG. 2, the clamping device 10 includes a center rod 11, two link arms 12, two clamping arms 13, multiple clamping heads 14 and an arm support 15.

The center rod 11 is extended in the axial direction of the clamping device 10 (vertical direction). The center rod 11 is movable in the vertical direction by means of an actuator such as air cylinder or hydraulic cylinder. The center rod is connected to the clamping arms 13 via the link arms 12. The center rod 11 moves in the vertical direction, whereby the clamping arms 13 are manipulated via the link arms 12.

The link arms 12 couple the center rod 11 with the clamping arms 13, and transmit the action of the center rod 11 to the clamping arms 13. Base ends of the link arms 12 are pivoted on the upper end of the center rod 11 by a center pin 16. Side ends of the link arms, which are extended sideward from the base ends, are pivoted on the middle portions of the clamping arms 13 by link pins 17.

The center pin 16 is provided at the upper end of the center rod 11. The link pins 17 are located above the center pin 16. Thus, the link arms 12 are supported such that they are extended obliquely upward from the upper end of the center rod 11. In other words, in the initial state (non-clamped state), the angle made by the link arms 12 is smaller than 180°.

The clamping arms 13 are extended in the vertical direction, and clamp the cylinder block 2 at the top ends thereof. The top end of the clamping arm 13 is formed with the clamping head 14, and the base end of the clamping arm is supported on the side of the arm support 15 by a support pin 18. The clamping arm 13 is rotatable in the lateral direction centered on the support pin 18 that is located at the side of the arm support 15. The middle portion of the clamping arm 13 is connected to the link arm 12 via the link pin 17.

The clamping head 14 contacts and presses the cylinder block 2. The clamping head 14 is projected inward from the top end of the clamping arm 13. The clamping heads 14 are attached to the surfaces of the clamping arms 13 which are facing with each other.

The clamping head 14 avoids the bearing portion 5 of the journal wall 4, thereby maintaining the product quality of the cylinder block 2 without affected by the pressing by the clamping heads 14.

The arm support 15 is located at the base end (lower end) of the clamping device 10, and extended in the lateral direction. At the both sides, the arm support 15 is provided with the support pins 18. The arm support 15 supports the clamping arms 13 via the support pins 18.

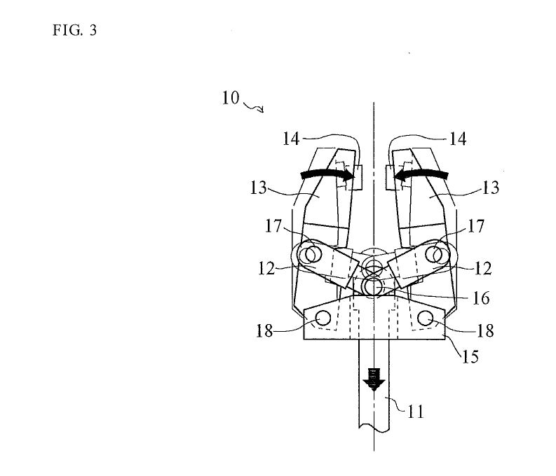

Referring to FIG. 3, the clamping action of the clamping device 10 is described below.

The actuator moves the center rod 11 downwardly so that the base ends of the link arms 12 are pulled in downward via the center pin 16. Thus, the rotative force around the center pin 16 is acted inwardly (arrow direction shown in FIG. 3) on the link arms 12. Due to the rotative force, the link pins 17 moves inward. The movements of the link pins 17 are cooperated with the rotations of the clamping arms 13 centered on the support pins 18.

After that, the distance between the clamping arms 13 is narrowed, thereby generating the clamping force between the clamping arms 13.

Releasing the clamping force by the clamping arms 13, the center rod 11 is moved upwardly, and the link arms 12 are rotated outward so that the distance between the clamping arms 13 is widened.

The clamping device 10 has a link configuration composed of the center rod 11, the link arms 12 and the clamping arms 13, in which the center rod 11 is actuated to control the movement (displacement) of the clamping arms 13.

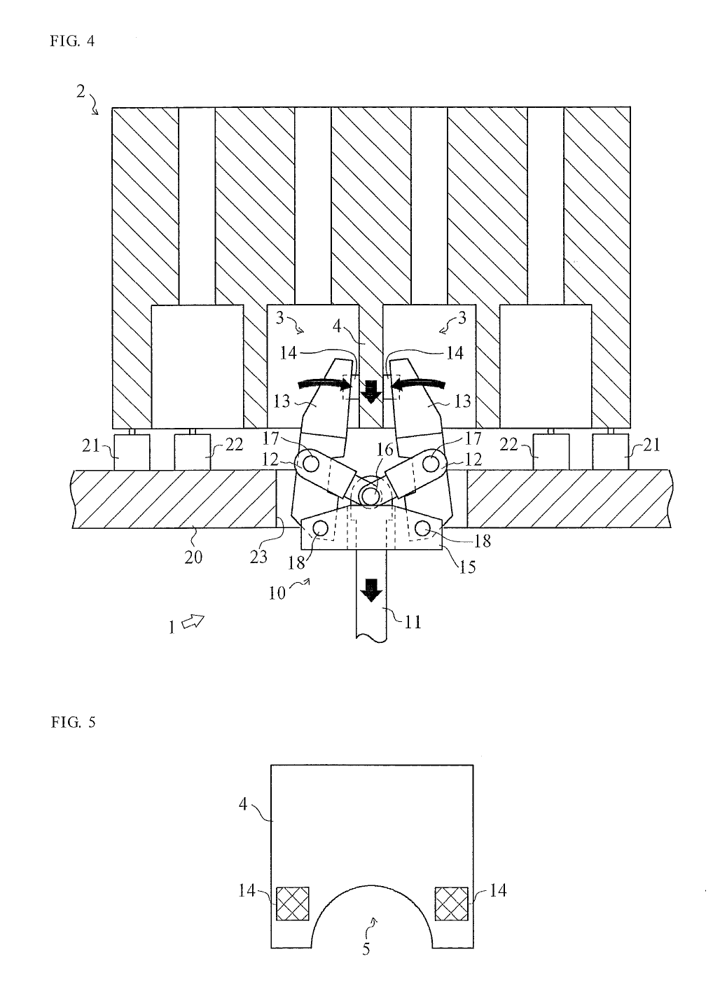

As illustrated in FIG. 4, the clamping device 10 clamps the cylinder block 2 from the lower side. More specifically, each of the clamping arms 13 is inserted into the crank case 3 of the cylinder block 2, and the center rod 11 is actuated, whereby the clamping arms 13 clamps the journal wall 4 from the side. Clamping with the clamping arms 13, the center rod 11 is moved downward to add a downward force to the journal wall 4 via the clamping heads 14, thereby fixing the cylinder block 2 such that the cylinder block is pressed downward by the downward force.

At that time, the cylinder block 2 is mounted on the positioning seats 21 disposed on the table 20, and the clamping device 10 projects upward through the hole formed in the table 20 and clamps the cylinder block 2 from underneath. Further, in the state that the clamping device clamps the cylinder block, the clamping device pulls the cylinder block 2 downwardly to press the cylinder block toward the table 20, thereby fixing the cylinder block on the table.

As described above, in clamping the cylinder block 2, the clamping device 10 grips it from underneath, so that the cylinder block 2 can be firmly fixed. Particularly, the clamping arms 13 for applying the fixing force to the cylinder block 2 can be shortened and improved in rigidity. As the result, the stability of the cylinder block 2 clamped by the clamping device is enhanced.

In other words, the distance between the point of effort of the clamping arm 13 (or the clamping head 14) and the fulcrum supporting the clamping arm 13 (or the support pin 18) can be shortened. Therefore, the total length of the clamping equipment can be shortened and the large clamping force for clamping the cylinder block 2 can be provided, thereby achieving the stable clamping.

Moreover, the clamping device 10 pulls in the cylinder block 2 downwardly to fix that strongly, so that the sufficient strength of fixing can be provided in any processing direction, along which the cylinder block 2 is processed.

The clamping device 10 is disposed inside of the outer shape of the jig 1 and clamps the cylinder block 2 from the bottom where the cylinder block 2 is laid on the table 20. So, there is no need to dispose the clamping unit in the outside of the jig 1, and therefore the jig 1 can be downsized. Furthermore, the clamping device 10 is not arranged around the cylinder block 2, or clamps the cylinder block internally, so that the clamping device 10 may not contact the processing tool for processing the cylinder block 2.

As depicted in FIG. 5, the clamping heads 14 contact and press the journal wall 4 at the portion except the semicircle bearing portion 5. When clamping the cylinder block 2, pressing the wall portion of the journal wall 4 which does not affect the product quality, the cylinder block 2 to be fixed is prevented from quality degradation.

The clamping heads 14 touch and apply pressure to the both sides of the bearing portion 5. In such case, the clamping heads 14 clamp the lower portion of the journal wall 4 located at the bottom of the cylinder block 2, hence the length of the clamping arms 13 can be minimized and firm clamping can be provided.

Notice that multiple clamping devices 10 can be employed according to the shape or size of the cylinder block 2, in which desired fixing strength can be provided.

### Industrial Applicability

The present invention can be applicable to a jig for fixing a cylinder block, and particularly to a fixing jig used in processing various parts (processing in various directions) of the cylinder block.

### Description of Numerals

1: jig (for fixing a cylinder block), 2: cylinder block, 3: crank case, 4: journal wall, 5: bearing portion, 10: clamping device, 20: table

1. A jig for fixing a cylinder block comprising:
a table on which the cylinder block is mounted such that crank cases of the cylinder block are located downside; and
a clamping device capable of projecting upward from the top of the table, clamping a journal wall disposed between the adjacent crank cases,
wherein the clamping device comprises two clamping arms, and each of the clamping arms is inserted into each of the crank cases adjacent to each other, whereby the clamping arms clamp the journal wall disposed between those crank cases.

2. The jig according to claim 1,
wherein the clamping device pulls in the cylinder block downward to press the cylinder block toward the table in the state that the clamping device clamps the journal wall of the cylinder block.

3. The jig according to claim 1,
wherein the clamping device clamps a part of the journal wall, the part is located at the side of bearing portion for a crank shaft.
